(19) United States
(12) Patent Application Publication
(10) Pub. No.: US 2004/0263818 A1
(43) Pub. Date: Dec. 30, 2004

(54) Apparatus and method for projecting pixel-based image information onto a light-sensitive material

(75) Inventors: Ulrich Kluter, Munich (DE); Reimund Munch, Munich (DE); Ralf Grosskloss, Murnau (DE); Thomas Hartmann, Uffing/Staffelsee (DE)

Correspondence Address: DARBY & DARBY P.C., P. O. BOX 5257, NEW YORK, NY, 10150-5257, US

(73) Assignee: AGFA-GEVAERT AKTIENGESELLSCHAFT, Leverkusen (DE)

(21) Appl. No.: 10/870,758

(22) Filed: Jun. 16, 2004

(30) Foreign Application Priority Data
Jun. 24, 2003 (EP) 03101848.4

(51) Int. Cl. G03B 27/54

(52) U.S. Cl. 355/67; 355/53

(57) ABSTRACT

An apparatus for optically projecting pixel-based image information onto a light-sensitive material (12) has an image generator (1) for physically representing the image information in the form of monochrome partial images in different exposure colors. A projected image of the physical representation is produced by an optical projection device (4) which includes an offsetting device (7, 38, 39, 38a, 39a, 38c, 39c) for laterally offsetting the projected image in the image plane of the apparatus. The offsetting device is controlled by a controller means in a manner that is dependent on the exposure color of the monochrome partial image currently being produced by the image generator.

### BACKGROUND OF THE INVENTION

The invention relates to an apparatus and a method for optically projecting pixel-based image information onto a light-sensitive material. In an apparatus and method of the kind that the invention seeks to improve, an image generator produces monochrome partial images in different exposure colors which are projected by an optical image-projecting device onto the light-sensitive material.

When producing an image of graphic information on a light-sensitive material, the aim is to maximize the detail resolution of the image. This is of particular importance in cases where the image-generating device is based on an electronic working principle. In electronic image-generating devices, the graphic information is generated as an assembly of individual pixels represented by individual indicating elements or image elements, where each of the indicating- or image elements is independently controlled by electronic means. However, electronic image-generating devices based on this concept—at least those that are within a reasonable cost range—have a resolution that is not adequate for producing high-resolution images at the quality level of photographs.

Thus, there is an interest in a technical solution where the projected image on the light-sensitive material has a higher resolution than the image generator, e.g., a liquid crystal device (LCD). This is accomplished by dividing the image data into a plurality of partial-content images, each of which covers a part of the total content area of the image to be produced on the light-sensitive material. The apparatus is designed accordingly, so that in each exposure of one of the partial-content images only a part of the surface of the light-sensitive material is exposed. One of the ways in which this concept can be realized is by covering a part of each LCD element with a mask. The parts of the light-sensitive material that are left unexposed in the projection of a first partial-content image are covered by the remaining partial-content images in the subsequent exposure steps. Thus, each LCD element produces a plurality of projected images, where each of the projected images of the same LCD element covers a different part of the light sensitive material and carries a different content of image information. As a result, a contiguous image is produced in the image plane with a multiple of the resolution of the LCD device. The foregoing process relates to one monochrome partial image of the total image information. In order to produce an image in colors, the process has to be repeated for each of the different exposure colors.

The foregoing method of resolution enhancement is used in devices where the image information is represented in an image generator based on an LCD-(liquid crystal device), DMD-(digital mirror device) or other light modulator and projected onto a light-sensitive material such as photographic paper.

Further according to this method, each of the LCD elements in an LCD device has a black-covered area (black matrix) which in a sharply focused image leads to an exposure gap on the photographic paper. By making a plurality of exposures in which the projected images on the photographic paper are laterally offset from each other and by simultaneously driving the LCD device with the appropriate image information for each of the mutually offset partial-content images, one can fill the exposure gaps with the required image data. A complete high-resolution image is produced in this manner as a composite of a plurality of partial-content images. The black matrix of the LCD device covers for example three fourths of the LCD surface. In this case, each side of the active portion of each LCD element is adjoined—vertically as well as horizontally—by a black area of equal dimensions as the active part of the LCD element.

To give an example, the data representing a high-resolution image can be divided into electronic representations of four partial-content images. If the LCD device generates a first partial-content image representing all points in even-numbered positions (0, 2, 4, . . . ) in the x-direction and even-numbered positions (0, 2, 4, . . . ) in the y-direction, a second partial-content image representing all points in even-numbered positions (0, 2, 4, . . . ) in the x-direction and odd-numbered positions (1, 3, 5, . . . ) in the y-direction, a third partial-content image representing all points in odd-numbered positions (1, 3, 5, . . . ) in the x-direction and odd-numbered positions (1, 3, 5, . . . ) in the y-direction, and a fourth partial-content image representing all points in odd-numbered positions (1, 3, 5, . . . ) in the x-direction and even-numbered positions (0, 2, 4, . . . ) in the y-direction, the image produced on the photographic medium by the four partial-image exposures will have four times the resolution of the LCD device. For example, if the LCD device has an array of 1600×1200 elements, the image produced by the forgoing exposure process will have 3200×2400 image dots. It is of course a prerequisite for this method, that the underlying image data have at least this level of resolution.

A method of producing a digital image is disclosed in EP 0 987 875, where in essence an LCD device is projected onto an image carrier by means of an objective lens system. By means of a tiltable glass plate, the projected pixels are moved into laterally offset positions in the image plane, and the image carrier is exposed one or more times for each of the offset positions.

In state-of-the-art systems of this kind, it has however been found that the precision with which the monochrome partial images are overlaid on each other on the image carrier surface is not always sufficient to present an overall impression of brilliance to a viewer.

### OBJECT OF THE INVENTION

The present invention therefore has the objective to achieve a higher level of precision in the superposition of the individual monochrome partial images in the different exposure colors, so that there is no discernible shift in position between monochrome partial images of different color.

### SUMMARY OF THE INVENTION

In an apparatus according to the invention for optically projecting pixel-based image information onto a light-sensitive material, an image generator produces monochrome partial images in different exposure colors which are projected by an optical image-projecting device onto the light-sensitive material. The projections of the partial images in the plane of the light-sensitive material are laterally offset relative to each other by an offsetting device. The apparatus is further equipped with controller means whereby the offsetting device is controlled in a manner that is dependent on the exposure color.

The scope of the invention also includes a method for optically projecting pixel-based image information onto a light-sensitive material, wherein monochrome partial images in different exposure colors are produced individually by an image generator and projected sequentially onto the light-sensitive material. In each of the sequential steps of producing a monochrome partial image and projecting the latter onto the light-sensitive material, the partial image is projected with a lateral offset in the plane of the light-sensitive material. The lateral offsetting function is controlled in a manner that is dependent on the exposure color.

The key to the inventive solution lies in recognizing the fact that different optical path lengths are associated with the optically offset projections of the images produced by the image generator in different exposure colors. The invention therefore proposes a concept whereby the offsetting device is controlled in a manner that is dependent on the exposure color for the partial image to be projected.

Specifically, the offsetting device is controlled so that the offset for each monochrome partial image is identical to the respective offsets of the monochrome partial images representing the other exposure colors for the same partial-content image.

In one embodiment of the invention, an individual image-generating element in a peripheral area of the image generator functions as a test element that cooperates with an arrangement of several sensor points at a location of the image plane that lies outside the area where the light-sensitive material is placed. Each time the exposure color is switched, the apparatus detects which of the sensor points is receiving the offset image of the test element. This information is used to control the offsetting device in such a manner that the image of the test element is offset to the specific sensor point that represents the control target.

However, in accordance with the invention it is preferred to use fixed correction factors which are specifically adapted to the apparatus and which have to be determined only once. These correction factors are used to compensate for the differences between the optical path lengths for the different wavelengths so that an embodiment using fixed correction factors produces the same desired result, i.e., a precise alignment of the monochrome partial images in the different exposure colors which together make up one of the partial-content images.

The image projected from the image generator onto the light-sensitive coating can be offset in any desired direction through an arrangement where two tiltable optical elements whose tilt axes are oriented at a right angle to each other are placed so that they follow each other in the light path. Thus, one of the tiltable optical elements offsets the projection in the x-direction of the image plane, while the other tiltable optical element offsets the projection in the y-direction. There are simple means of achieving a high level of precision in the tilting movement of the optical elements, so that the projected image of the pixels on the light-sensitive coating is highly reproducible.

An embodiment where two independent motors are used to move the tiltable optical elements has the advantage that the projected images of the image generator can be moved in any desired direction and by any desired distance. This offers the advantageous possibility of a calibration mode in which the individual pixels are subjected to a calibration offset that is different from the offset used in the actual photo-printing process.

The calibration mode serves to identify defective elements of the image generator (i.e., elements that are either too bright or too dark), so that appropriate correction algorithms can be applied to the image data before the exposure process. In the calibration mode, the defective pixel elements need to be represented in a way that makes them as conspicuous as possible and thus easy to detect. The lateral offset of the projection of the image generator is therefore controlled according to a pattern where the individual images of each pixel element are projected into adjacent raster positions in the image plane. Thus, if the resolution of the image generator is increased by a factor of four, every element of the image generator is represented in the image plane by a macro pixel that is four times the size of an individual pixel image. As a result, a defective element will be clearly visible.

On the other hand, if an element of the image generator fails between two calibrations, the defective element should be as inconspicuous as possible in the printed images. Thus, for making the exposures with the image data, the offset of the projections of the image generator is controlled in such a way that the individual projected images of each pixel element are spaced apart by more than one raster position. As a result, a defective image generator element will not be represented by a conspicuous macro pixel but by as many separate smaller pixels as there are offset positions, where the defective pixels are spaced at a certain distance from each other, so that they are almost indiscernible to the naked eye.

Given the ability to offset the projected image of the image generator in any desired direction by any desired amount, the imaging process can be controlled in such a way that a defective element of the image generator will be as inconspicuous as possible in the photo-printed image.

Therefore, when making a set of exposures from given image data, the lateral shifting of the projection is controlled in such a way that the sequentially shifted projections of an individual image-generating element in the different partial-content images are not immediately adjacent to each other, but are spaced farther apart. As a result, a defective image-generating element will not lead to a conspicuous macro pixel in the photo-printed image. Rather, the defective element will produce as many spatially separated smaller image pixels as there are offset positions, so that the defective image pixels are almost indiscernible to the naked eye.

In a preferred embodiment of the invention, the tiltable optical elements are moved by cam disks, each of which is driven separately by its own motor. Specific fixed positions of the cam disks correspond to each of the monochrome partial images.

Each of the different partial-content images is projected onto the light-sensitive material as a set of monochrome partial images in the different exposure colors. If the complete coverage of the content area in the image plane is divided into four partial-content images, each of the four partial-content images is further divided into monochrome partial images of different color, for example blue, green and red. The photo-printing process for a complete picture therefore requires twelve individual exposures.

In an advantageous embodiment, the contour of each of the cam disks is divided into six curve segments, each of which runs at a different radial distance from the center of rotation, with all points of a curve segment being equidistant from the center of rotation. The six curve segments can be about equally distributed over the circumference of a cam disk, so that the cam disks can be driven by low-cost stepper motors with only modest requirements on their positional accuracy.

Since one of the cam disks controls the offset of the protected image in the x-direction and the second cam disk controls the offset in the y-direction, an arrangement where the image data are subdivided into four partial-content images requires only two positions on each cam disk for offsetting the projections of the partial-content images from one position to the other. However, as each of the partial-content images is further subdivided into three monochrome partial images requiring different respective positions of the optical offsetting device, the contour of each cam disk is divided into the six curve segments as described above.

The cam disks control the tilt angle of two planar-parallel glass plates, where one glass plate serves to offset the projected image in the x-direction, and the other glass plate serves to offset the projected image in the y-direction.

### BRIEF DESCRIPTION OF THE DRAWINGS

Additional features and advantages of the invention will become apparent from the following description of preferred embodiments with references to the attached drawings, wherein

FIG. 1 represents the light path in an embodiment of the apparatus according to the invention,

FIG. 2 illustrates an imaging process according to the state of the prior art,

FIG. 3 illustrates an imaging process according to the present invention,

FIG. 4 represents a further embodiment of an apparatus according to the invention, and

FIG. 5 illustrates a detail of the drive mechanism shown in FIG. 4.

### DETAILED DESCRIPTION OF PREFERRED EMBODIMENTS

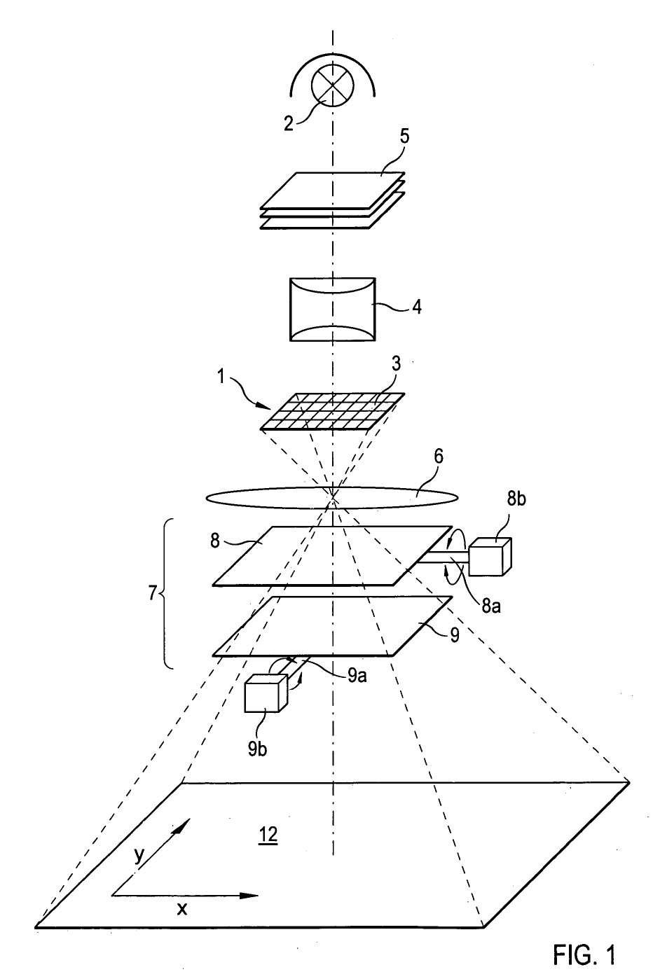

FIG. 1 gives a perspective view of the overall structure of an apparatus according to the invention which is used to project image information onto the light-sensitive coating of a photographic material. The image generator in the illustrated embodiment consists of a transmissive element, more specifically an LCD device. However, it is also possible to use other transmissive elements or a reflective element such as, e.g., a digital micromirror device (DMD). As a reference line for the orientation of the reader, the optical axis of the optical image-projecting system is shown in FIG. 1 as a dash-dotted line.

The LCD device 1 is used to represent a pattern which is illuminated by means of a light source 2. The pattern on the LCD device 1 is generated by means of individual LCD elements 3, which are individually driven and are partially covered by a black matrix (not shown in FIG. 1). In order to quadruple the resolution of the projected image in comparison to the resolution of the LCD device 1 that is used in the apparatus, three fourths of the surface area of each LCD element are covered up by the black matrix.

The light of the lamp 2 is colored by means of filters 5 that are individually swiveled into and out of the light path. The condenser 4 aligns the light, so that the LCD device can be illuminated with hard light.

As an alternative to a lamp with color filters, the colored light required for the imaging process can also be produced by LEDs (light-emitting diodes). With this solution it is irrelevant whether one LED array of mixed colors is used or the light of a plurality of LED arrays with different respective colors is merged in the light path.

An optical projection system 6 serves to project the pattern from the LCD device 1 onto the photographic paper 12.

An offsetting device 7 is arranged between the optical projection system 6 and the light-sensitive coating of the photographic paper 12, whereby the projected image of the LCD elements 3 can be laterally offset in the image plane.

The offsetting device 7 includes two tiltable planar-parallel glass plates 8 and 9 which are arranged so that one follows the other in the light path between the optical projection system 6 and the image plane where the light-sensitive coating of the photographic paper 12 is located.

The glass plates 8 and 9 have the function to impart a parallel offset to the projection light path, where the magnitude of the offset depends on the respective positions of the glass plates. This means that the image of each individual LCD element 3 projected into the plane of the photographic paper 12 can be offset within a considerable range with the distance and angle of the offset being freely selectable. The offset is effected by tilting the two planar-parallel glass plates 8 and 9. The position of the glass plate 8 determines the y-component of the offset, and the position of the glass plate 9 determines the x-component. Any desired offset can thus be realized through a combination of different tilt angles of the two glass plates.

The preferred thickness for the tiltable planar-parallel glass plates 8 and 9 is 1 to 2 millimeters. The centers of the glass plates coincide with the optical axis of the system. Consequently, the offsetting device can be realized at a favorable cost, since it adds no optical elements with prescribed surface curvatures to the system.

The two glass plates 8 and 9 are rotatably supported and are tilted about their respective tilt axes by drive mechanisms 8b and 9b. The tilt axes are identified as 8a and 9a. A detailed description of the drive mechanisms 8b and 9b follows below.

As the image-generating elements of an LCD device have a rectangular shape, the tilt axes 8a and 9a are aligned parallel to the base lines of the LCD elements 3 and oriented at a right angle to each other. In order to prevent a distortion of the projected image, the tilt axes 8a and 9a are arranged in parallel planes that are traversed at a right angle by the optical axis of the light path. Both tilt axes intersect the optical axis.

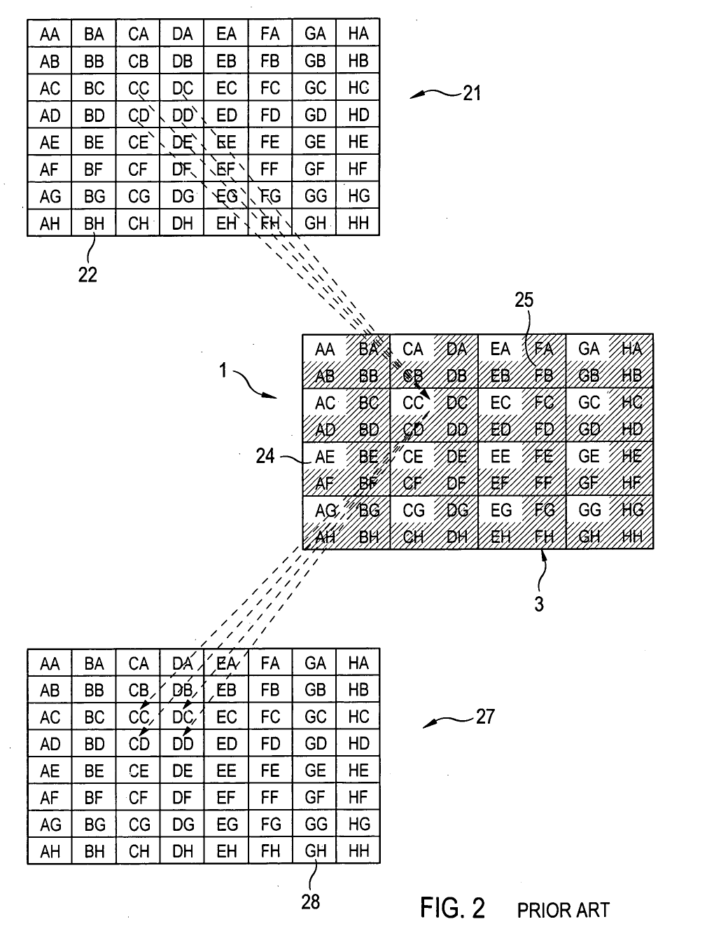

Element 21 in FIG. 2 represents a memory plane in which the image data are stored with high resolution. The memory plane 21 contains a multitude of memory cells 22. The information in the memory cells 22 is used to drive the LCD device or, in more specific terms, to drive the multitude of LCD elements 3 that make up the LCD device 1.

In the illustrated embodiment, only one fourth of the image data of the memory plane 21 is represented at one time by the LCD device 1. The image data of each individual pixel are identified by a letter combination, wherein the first letter identifies the column and the second letter identifies the row of the matrix. A first partial-content image is composed of all pixels identified by letter combinations in which the first letter is A, C, E, or G and the second letter is likewise A, C, E, or G. A second partial-content image is based on the image data with the first letters B, D, F, or H and the second letters A, C, E, or G. The third partial-content image uses image data with letter combinations in which the first as well as the second letter is a B, D, F or H, while the image data for the fourth partial-content image have an A, C, E or G for the first letter and a B, D, F or H for the second letter.

The partial-content image generated by the LCD device 1 is projected by means of the light source 2 and the optical projection system 6 onto the light-sensitive paper 12. The LCD elements 3 of the LCD device 1 have three fourths of their respective surface areas covered up by a black matrix 25, which causes exposure gaps in the projected image on the light-sensitive paper. The active one-fourth of each LCD element 3 is identified by the reference symbol 24.

In order to project the partial images into the image plane in such a way that they will not overlap each other, the apparatus includes an offsetting device 7 for transposing the projected image 27 by an amount equivalent to the width and/or height of an image dot 28 of the projected image 27. The projected partial image is offset vertically and/or horizontally in accordance with the respective content part of the image to be produced. In order to visualize the sequence in which the partial-content images are assembled, each LCD element 3 of the LCD device 1 is shown with the entire set of image data that are sent from the storage cells 22 for processing by that LCD element.

The projected image 27 is composed of individual image dots 28 which are identified according to their originating image data in the storage cells 22.

If one of the plurality of LCD elements 3 of the LCD device 1 is too bright or too dark, this will manifest itself in a defective representation of all image dots produced by that LCD element. In the calibrating procedure that is illustrated in FIG. 2, a faulty LCD element will thus produce a correspondingly large image dot in the projected image 27, which makes the defect clearly recognizable so that it can be corrected. For example, if the LCD element in the second column and second row of the LCD device 1 is defective, i.e., the LCD element that is driven by the image data CC, DC, DD and CD, the projected image will show a flaw that corresponds to the image dots CC, DC, DD and CD. The coordinates of this flaw in the image plane can be determined, and the flaw can be corrected by an appropriate calibration algorithm.

On the other hand, when the system is operating in a normal picture production mode, one aims to keep such defective or even totally inoperative LCD elements invisible in the projected image 27. The production mode is therefore programmed in such a way that neighboring image dots 28 in the projected image 27 never originate from the same LCD element 3 of the LCD device 1.

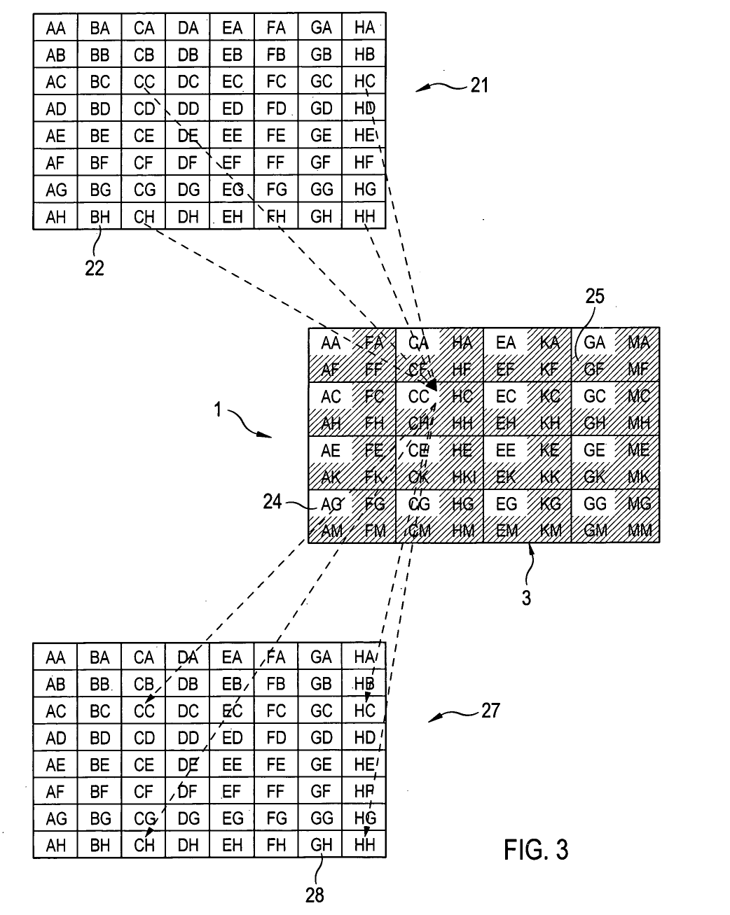

To visualize the foregoing process, FIG. 3 shows a part of the image data of a complete image in the memory plane 21. The image data in the individual memory cells 22 are identified in the same manner as in FIG. 2.

Like the memory plane 21, the LCD device 1 is shown only in part. The image dots to be generated by each of the LCD elements 3 are likewise indicated in the three fourths covered by the black matrix 25 and in the active one-fourth of each field representing one of the LCD elements 3.

Preferably, the image information is again divided into four partial-content images. The first of the partial-content images is again (as in FIG. 2) based on the image data at the memory addresses consisting of a combination of the letters A, C, E or G. The second of the partial-content images uses imaged data identified by combinations of a first letter F, H, K or M and a second letter A, C, E or G. The third of the partial-content images uses image data identified by combinations in which the first as well as the second letter is F, H, K or M, while the image data for the fourth of the partial-content images uses an A, C, E or G for the first letter and an F, H, K or M for the second letter.

The exposure of the first of the partial-content images of the foregoing description is performed in the same manner as in the example of FIG. 2. For the exposure of the second partial-content image, however, the projection into the image plane 12 is horizontally transposed by five times the width of an image dot 28 rather than only a single width. The offset has to be equal to an odd number of image dots. The same applies to the exposure of the third of the partial-content images where the offset is in the vertical direction. In the illustrated example, the projection of the third partial-content image is offset from the projection of the second partial-content image by five times the height of an image dot.

However, the partial-content images could also be offset from each other by a different odd multiple of the height of one image dot. The vertical offset does not need to equal the horizontal offset in terms of the number of image dots. For the fourth of the partial-content images, the projection is transposed horizontally again by the same amount as for the second partial-content image, but in the opposite direction.

The exposures for the individual partial-content images are made one after the other, so that the sequence of images adds up to a monochrome total image 27. In the exposures of the individual partial-content images, the lateral shifts which are applied when the image data from the storage cells 22 of the memory plane 21 are transferred to the LCD device are reversed by the offset, so that the image produced in the image plane is an exact representation of the image that is stored in the memory plane 21, i.e., the order of sequence and the arrangement of the image dots 28 corresponds exactly to the image data that are stored in the storage cells 22 of the memory plane 21.

As in FIG. 2, the LCD element in the second column and second row of the LCD device 3 of FIG. 3 is again assumed to be defective. This defective LCD element would normally produce a projected image based on the image data CC, HC, HH and CH. Since the order of arrangement in the memory plane corresponds to the order of arrangement of the resulting image dots in the exposed image 7, the black image dots CC, HC, HH and CH produced by the defective LCD element are not directly adjacent to each other, but are spaced from each other by the same number of places that separates them in the memory plane. Thus, the defective image dot CC lies five columns to the left of the defective image dot HC, five rows above the defective image dot CH, and five rows above as well as five columns to the left of the defective image dot HH.

As a result, the image flaw caused by the defective LCD element is distributed over four small spaced-apart dots that are less distracting to the eye of the viewer than an image fault that would result if the same procedure that was used in the calibration mode of FIG. 2 were used also in the production mode.

The description of FIGS. 1 and 2 is based on the assumption that image data stored in four memory cells 2 are represented through one LCD element 3. Of course, it would also be possible to use one LCD element 3 to represent the image data from e.g., six, eight, nine, twelve, or sixteen memory cells 2. Accordingly, the respective numbers of partial images being generated would be six, eight, nine, twelve, or sixteen, rather than four. Here, again, the spacing between the different image dots 28 generated by one LCD element should be selected so that in the case of a defective LCD element, the associated image dots will not appear as one contiguous large image dot to the eye of the viewer.

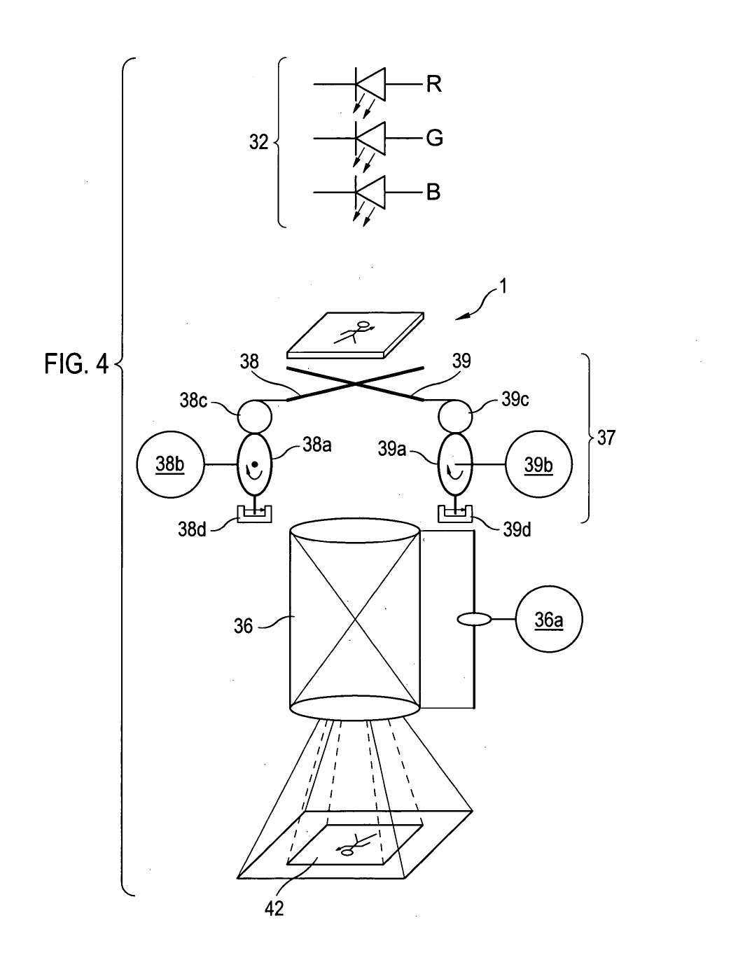

The embodiment shown in FIG. 4 uses again two glass plates 38, 39 to offset the partial-content images from each other. The entire offsetting device 37 for transposing the projected image of the LCD device 1 consists of the two planar-parallel glass plates 38, 39, the cam disks 38a, 39a, the cam disk drive mechanisms 38b, 39b which are configured as stepper motors, the cam follower devices 38c, 39c, and the zero point sensors 38d, 39d.

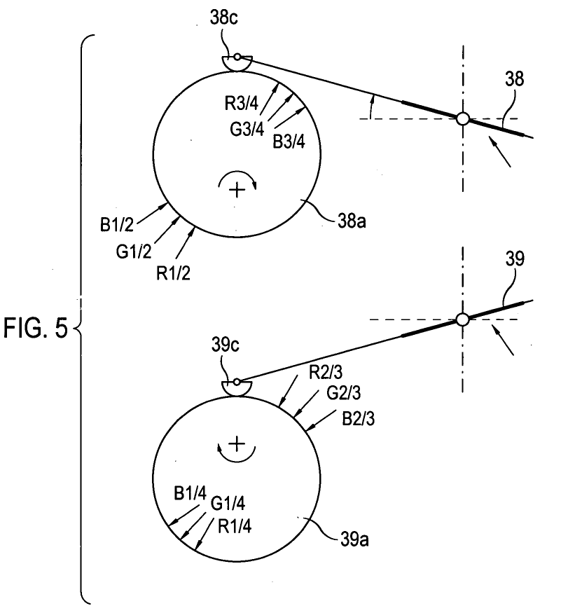

The angle of rotation or number of steps of the motors 38b and 39b has a functional relationship to the tilt angle of the glass plates 38 and 39 that is defined by the shape of the cam disks. Due to the large reduction ratio between the angle of rotation of the motor and the tilt angle of the glass plate, for the cam disks, it is possible to perform a fine adjustment of the light path. The fine adjustment is necessary to compensate for possible variations that lie within manufacturing tolerance. In the fine adjustment process, the points B3/4, G3/4, R3/4, B1/2, G1/2, R1/2, B2/3, G2/3, R2/3, B1/4, G1/4, R1/4 are defined on the contour curves of the cam disks (see FIG. 5).

The image generated by the LCD device 1 is projected through a zoom objective 36 with a zoom drive mechanism 36a. An LED arrangement 32 with fast-switching red, green and blue LEDs serves as illumination source. It is irrelevant whether the LEDs are configured as one arrangement of mixed colors, e.g., on one circuit board, or as separate one-color arrangements whose light is directed into the light path by means of mirrors. The image produced in the plane of the photographic paper is identified by the reference symbol 42.

FIG. 5 illustrates in detail how the glass plates are controlled. The embodiment of FIG. 5 is based on the assumption that the image is divided into four partial-content images, each of which is made up of three exposure components in blue, green and red, respectively. However, it is also possible to divide the total image into a different number of partial-content images, but this would require a different configuration of the cam disks.

At the beginning of an exposure process for the production of a picture, the cam disks 38a and 39a are moved to a defined reference position that is found by means of the two zero point sensors 38d and 39d. Subsequently, the stepper motors 38b and 39b are driven to a position where the cam follower element 38c is at point B1/2 of the contour of cam disk 38a, and the cam follower element 39c is at point B1/4 of the contour of cam disk 39a. This is the position of the glass plates where the blue component of the first partial-content image is exposed.

For the exposure of the green component of the same partial-content image, the cam discs 38a and 39a need to be advanced by only a small amount. The small movement of the cam disk is required in order to ensure that the green component of the first partial-content image is projected in exactly the same position as the preceding exposure for the blue component of the first partial-content image. Due to the small angle of rotation to reach the points G1/2 and G1/4 and also due to the fast switch-over of the light source 32, the exposures for the different color components can follow each other at very short time intervals.

For the subsequent exposure with the red component of the first partial-content image, the cam follower element 38c needs to be at the point R1/2 of the cam disk 38a, and the cam follower element 39c needs to be at the point R1/4 of the cam disk 39a. The exposure with the red color component concludes the exposure of the first partial-content image in all three colors.

To perform the blue-color exposure for the second partial-content image, the cam disk 38a is turned back so that the cam follower element 38c is again at point B1/2 of the cam disk contour. The cam disk 39a, however, is advanced by an angle of about 180° until the cam follower element 39c is at point B2/3 of the cam disk 39a. This is the position for the exposure of the blue color component of the second partial-content image.

For the exposures in the colors green and red of the second partial-content image, the cam disk 38a is advanced, respectively, to the points G1/2 and R1/2, and the cam disk 39a is advanced to the points G2/3 and R2/3, analogous to the procedure for the first partial-content image.

The exposures for the third partial-content image are performed with the cam disk 38a in the positions B3/4, G3/4 and R3/4 and with the cam disk 39a in the same positions B2/3, G2/3 and R2/3 that were used for the exposure of the second partial-content image. This requires the cam disk 38a to be advanced by about 180° for the blue component of the third partial image, while the cam disk 39a only has to be returned to the position B3/4.

The exposures for the fourth partial-content image are performed with the cam disk 38a once more at the positions B3/4, G3/4 and R3/4, while the cam disk 39a needs to be set to the same points B1/4, G1/4 and R1/4 as for the first partial-content image.

What is claimed is:

1. An apparatus for optically projecting pixel-based image information onto a light-sensitive material that is located in an image plane of said apparatus, wherein the apparatus comprises:
an image generator which produces a physical representation of the pixel-based image information in the form of monochrome partial images in different exposure colors;
an optical projection device which produces a projected image of said physical representation in the image plane;
an offsetting device for laterally offsetting said projected image in said image plane; and
controller means for controlling the offsetting device in a manner that is dependent on which of the different exposure colors is associated with a monochrome partial image currently being produced by said image generator.

2. The apparatus of claim 1, wherein the controller means employs correction factors that effect a compensation for differences between optical path lengths in the different exposure colors.

3. The apparatus of claim 1, wherein the offsetting device comprises a first optical element and a second optical element arranged so that said first and second optical elements follow one another in a light path of the apparatus, and wherein each of said first and second optical elements is movable.

4. The apparatus of claim 3, wherein the first and second optical elements are tiltable on tilt axes that are oriented at a right angle to each other.

5. The apparatus of claim 3, wherein the first optical element is movable by a first motor and the second optical element is movable by a second motor, said first and second motors being independent of each other.

6. The apparatus of claim 5, wherein said first motor drives said first optical element by way of a first cam disk with a first center of rotation and a first contour curve, and said second motor drives said second optical element by way of a second cam disk with a second center of rotation and a second contour curve, and wherein each of the monochrome partial images corresponds to a specific first contour point on said first contour curve and a specific second contour point on said second contour curve.

7. The apparatus of claim 6, wherein said first contour curve has six specific first contour points with different respective distances from the first center of rotation and said second contour curve has six specific second contour points with different respective distances from the second center of rotation.

8. The apparatus of claim 4, wherein each of the first and second optical elements comprises a planar-parallel glass plate.

9. The apparatus of claim 1, wherein the image generator comprises a liquid crystal display device.

10. A method of optically projecting pixel-based image information onto a light-sensitive material that is located in an image plane of a projection device, wherein the method comprises:
producing a physical representation of the pixel-based image information in the form of monochrome partial images in different exposure colors by means of an image generator;
producing a projected image of said physical representation in said image plane by means of said projection device; and
laterally offsetting said projected image in said image plane, wherein said offsetting is controlled in a manner that is dependent on which of the different exposure colors is associated with a monochrome partial image currently being produced by said image generator.

11. The method of claim 10, further comprising:
subdividing the pixel-based image information of each monochrome partial image into a plurality of partial-content images; and
projecting each of the partial-content images onto the light-sensitive material with a lateral offset relative to every other of the partial-content images.

12. The method of claim 11, further comprising:
in a first step, projecting a first partial-content image onto the light-sensitive material in a first of the different exposure colors; and;
in further steps, projecting the first partial-content image onto the light-sensitive material in further different exposure colors.
